(19) United States
(12) Patent Application Publication
(10) Pub. No.: US 2024/0428799 A1
(43) Pub. Date: Dec. 26, 2024

(54) SYSTEM AND METHOD FOR DETERMINING MULTI-PARTY COMMUNICATION INSIGHTS

(71) Applicant: VERIZON PATENT AND LICENSING INC., Basking Ridge, NJ (US)

(72) Inventors: Karthick KALIANNAN NEELAMOHAN, Namakkal (IN); Tarun NAGPAL, Bangalore (IN); Kunal SACHDEVA, Kanpur (IN); David SKURATOWICZ, Felton, CA (US); Sarat KOLLIMARLA, Jersey City, NJ (US)

(73) Assignee: VERIZON PATENT AND LICENSING INC., Basking Ridge, NJ (US)

(21) Appl. No.: 18/337,667

(22) Filed: Jun. 20, 2023

(51) Int. Cl. G10L 17/02; G06V 30/19; G10L 17/04; G10L 17/06

(52) U.S. Cl. CPC G10L 17/02; G06V 30/19; G10L 17/04; G10L 17/06

(57) ABSTRACT

A natural language processing (NLP) framework enables providing content and participant insights from multi-party communications (MPC). MPC insights can include a summary of the MPC, relevant keywords or highlights of the MPC, chapter names, and a title or header of the MPC. For a given speaker, the MPC insights can include a speaker specific focused summary or relevant keywords.

### BACKGROUND

Interpersonal and multi-party communications (MPCs) such as conferences, meetings, and calls are the cornerstone of enterprise development and growth. With the rapid adoption of video based communications as the de facto method for communicating with teammates and colleagues, the number of communications and the amount of data regarding such communications has increased exponentially. Current methods of summarizing or recalling the content of such communication are essentially limited to manual notes by participants or long unreliable digital transcripts that still require human input for context and relevancy determination.

### BRIEF DESCRIPTION OF THE DRAWINGS

The foregoing and other objects, features, and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure:

FIG. 1 is a block diagram illustrating an example environment within which the systems and methods disclosed herein could be implemented according to some embodiments.

FIG. 2 is a block diagram illustrating components of a natural language (NL) conversation system according to some embodiments.

FIG. 3A-FIG. 3D illustrate a flow diagram of a method for generating MPC insights according to an embodiment.

FIG. 4 is a flow diagram illustrating a method for generating diarized MPC data according to an embodiment.

FIG. 5 is a flow diagram illustrating a method for generating MPC keywords according to an embodiment.

FIG. 6 is a flow diagram illustrating a method for generating a trained chapterization model according to an embodiment.

FIG. 7 is a flow diagram illustrating a method for generating a trained machine learning (ML) model according to an embodiment.

FIG. 8 illustrates an example event timeline according to some embodiments.

FIG. 9 illustrates an example MPC summary according to some embodiments.

FIG. 10 illustrates another example of a graphical rendering comprising MPC insights according to an embodiment.

FIG. 11 illustrates an example of a graphical rendering comprising MPC insights according to an embodiment.

FIG. 12 illustrates another example of a graphical rendering comprising MPC insights according to an embodiment.

FIG. 13 is a block diagram of a device according to some embodiments.

### DETAILED DESCRIPTION

The present disclosure describes a natural language processing (NLP) framework for providing content and participant insights from multi-party communications (MPC). In some embodiments, MPC insights can include a summary of the MPC. In some embodiments, the MPC insights can include a one or more chapters (e.g., logical content segments) of the MPC. In some embodiments, MPC insights can include a title or header for the MPC. In some embodiments, MPC insights can include MPC highlights such as keywords, persons, locations, and date and time. In some embodiments, MPC insights can be participant or speaker specific. For example, In some embodiments, for a given speaker the MPC insights can include a speaker specific focused summary or relevant keywords.

In some aspects, the techniques described herein relate to a method generating MPC insights. In some aspects, the method can include obtaining multi-party communication (MPC) data corresponding to an MPC, the MPC data comprising an audio component and an event timeline, and generating diarized MPC data based on the MPC data by segmenting the audio component and assigning an anonymized speaker label to each segment. In some embodiments, the method can also include generating processed diarized MPC data by identifying the speaker corresponding to the anonymized speaker label based on the event timeline. In some aspects, the method further includes applying a summarization model to the processed diarized MPC data to generate an MPC summary; and determining an MPC insight corresponding to the MPC based on the MPC summary and the MPC data.

In some aspects, the techniques described herein relate to a non-transitory computer-readable storage medium for storing instructions executable by a processor. In some aspects, the instructions include obtaining multi-party communication (MPC) data corresponding to an MPC, the MPC data comprising an audio component and an event timeline, and generating diarized MPC data based on the MPC data by segmenting the audio component and assigning an anonymized speaker label to each segment. In some aspects, the instructions also include generating processed diarized MPC data by identifying the speaker corresponding to the anonymized speaker label based on the event timeline. In some aspects, the instructions further include applying a summarization model to the processed diarized MPC data to generate an MPC summary, and determining an MPC insight corresponding to the MPC based on the MPC summary and the MPC data.

In some aspects, the techniques described herein relate to a device comprising a processor. In some aspects, the processor can be configured to obtain multi-party communication (MPC) data corresponding to an MPC, the MPC data comprising an audio component and an event timeline, and generate diarized MPC data based on the MPC data by segmenting the audio component and assigning an anonymized speaker label to each segment. In some aspects, the processor can also be configured to generate processed diarized MPC data by identifying the speaker corresponding to the anonymized speaker label based on the event timeline. In some aspects, the processor can be further configured to apply a summarization model to the processed diarized MPC data to generate an MPC summary and determine an MPC insight corresponding to the MPC based on the MPC summary and the MPC data.

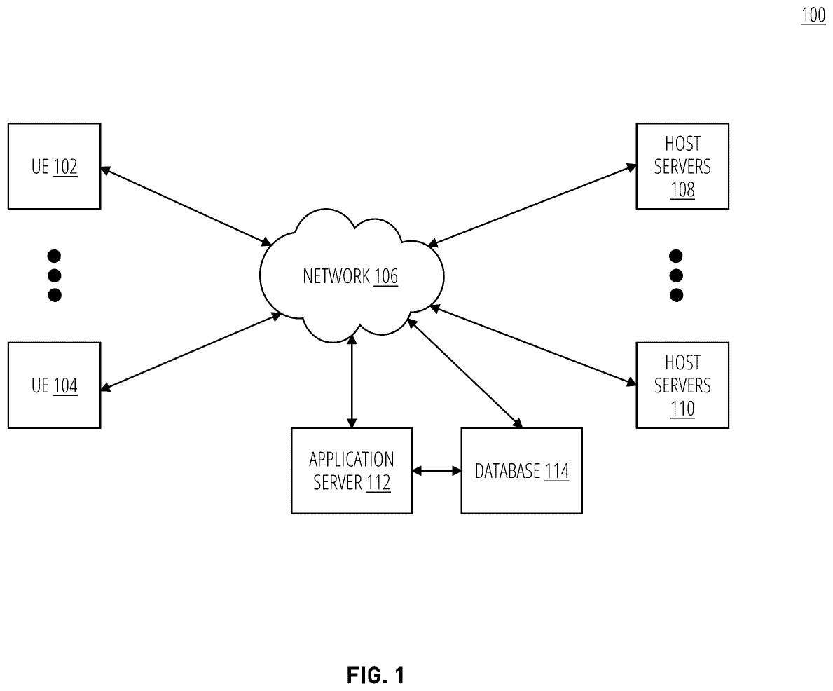

FIG. 1 is a block diagram illustrating an example environment within which the systems and methods disclosed herein could be implemented according to some embodiments.

FIG. 1 shows components of a general environment in which the systems and methods discussed herein may be practiced. Not all the components may be required to practice the disclosure, and variations in the arrangement and type of the components may be made without departing from the spirit or scope of the disclosure. As shown, system 100 can include user equipment (UE) 102-104, network 106, host servers 108-110, application server 112, and database 114.

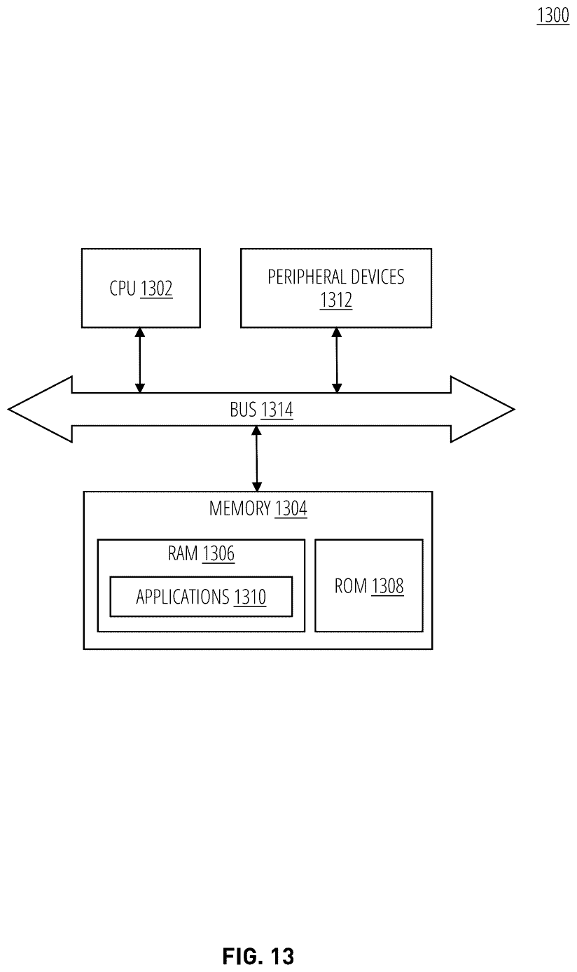

In the illustrated embodiment, UE 102-104 can communicate with host servers 108-110 and application server 112 via network 106. In some embodiments, UE 102-104 can include virtually any computing device capable of communicating with other UE, devices, or servers over a network, such as network 106. In some embodiments, UE 102-104 may be capable of sending or receiving signals, such as via a wired or wireless network, or may be capable of processing or storing signals, such as in memory as physical memory states. As examples, UE 102-104 can include mobile phones, smart devices, tablets, laptops, sensors, IoT devices, autonomous machines, unmanned aerial vehicles (UAVs), wired devices, wireless handsets, and any other devices equipped with a cellular or wireless or wired transceiver, whether portable or non-portable. In some embodiments, UE 102-104 can also be described generally as client devices. In some embodiments, UE 102-104 can be a device 1300 as described with respect to FIG. 13.

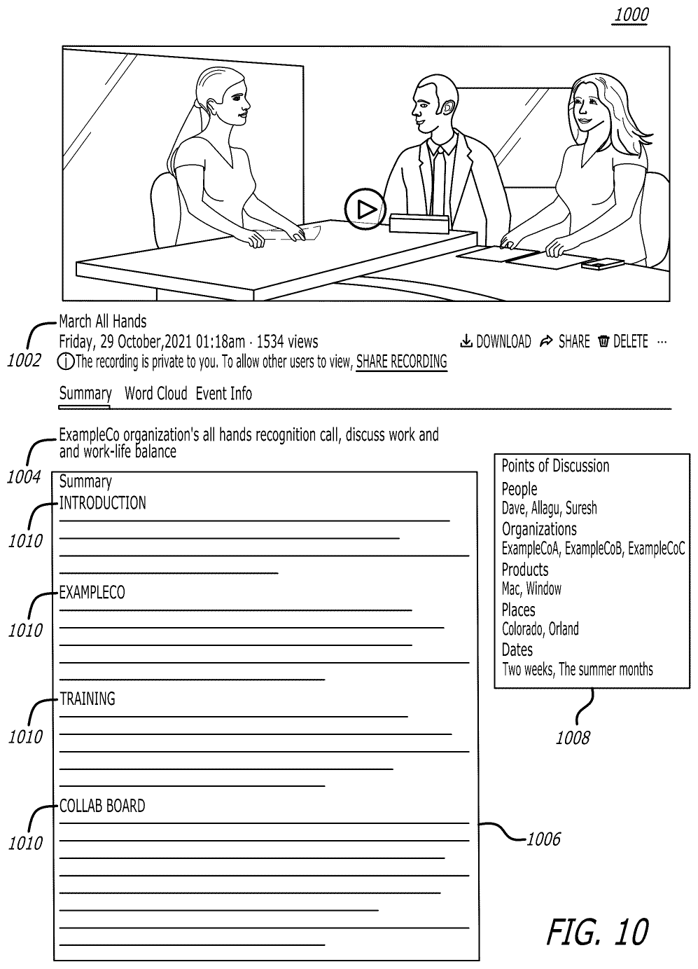

In some embodiments, UE 102-104 can include at least one client application or program that is configured to communicate with a host sever, such as, host servers 108-110 or application server 112. In some embodiments, the client application can include a capability to provide and receive textual content, graphical content, audio content, and the like. In some embodiments, the client application can further provide information that identifies itself and/or the UE including a type, capability, name, and the like. In some embodiments, the client application can receive MPC insights and other MPC data from a server. In some embodiments, the client application can display the MPC insights and MPC data through a graphical interface. FIG. 10-FIG. 12 illustrate examples of graphical rendering comprising MPC insights.

According to some embodiments, network 106 can be configured to couple UE 102-104, host servers 108-110, and/or application server 112. In some embodiments, network 106 can be a wired network, a wireless network, or a combination thereof. In some embodiments, network 106 is enabled to employ any form of computer readable media or network for communicating information from one electronic device to another. In some embodiments, network 106 can include the Internet, a local area network (LAN), a wireless LAN, a wide area network (WAN), a mobile edge computing (MEC) network, a private network, a cellular network, and the like. According to some embodiments, a “network” should be understood to refer to a network that may couple devices so that communications may be exchanged (e.g., between a server and a client device or between servers) including between wireless devices coupled via a wireless network, for example. In some embodiments, a network can also include mass storage or other forms of computer or machine readable media (e.g., database 114), for example.

In some embodiments, network 106 can include an access network and/or core network (not shown) of a mobile network. In general, the access network can include at least one base station that is communicatively coupled to the core network and coupled to zero or more UE 102-104. In some embodiments, the access network can comprise a cellular access network, for example, a fifth-generation (5G) network or a fourth-generation (4G) network. In one embodiment, the access network can comprise a NextGen Radio Access Network (NG-RAN), which can be communicatively coupled to UE 102-104. In an embodiment, the access network can include a plurality of base stations (e.g., eNodeB (NB), gNodeB (gNB)) communicatively connected to UE 102-104 via an air interface. In some embodiments, the air interface can comprise a New Radio (NR) air interface. For example, in some embodiments, in a 5G network, UE 102-104, host servers 108-110, and/or application server 112 can be communicatively coupled to each other and to other devices. And, in some embodiments, for example, such coupling can be via Wi-Fi functionality, Bluetooth, or other forms of spectrum technologies, and the like.

In some embodiments, the access network and/or core network may be owned and/or operated by a service provider or an NO and provides wireless connectivity to UE 102-104 via the access network. In some embodiments, the core network can be communicatively coupled to a data network. In some embodiments, the data network can include one or more host servers 108-110. In some embodiments, network 106 can include one or more network elements. In some embodiments, network elements may be physical elements such as router, servers and switches or may be virtual Network Functions (NFs) implemented on physical elements.

According to some embodiments, host servers 108-110 and/or application server 112 can be capable of sending or receiving signals, such as via a wired or wireless network (e.g., network 106), or may be capable of processing or storing signals, such as in memory as physical memory states. In some embodiments, host servers 108-110, application server 112 can store, obtain, retrieve, transform, or provide content and/or content data in any form, known or to be known, without departing from the present disclosure.

As used herein, a “server” should be understood to refer to a service point which provides processing, database, and communication facilities. In some embodiments, the term “server” can refer to a single, physical processor with associated communications and data storage and database facilities, or it can refer to a networked or clustered complex of processors and associated network and storage devices, as well as operating software and one or more database systems and application software that support the services provided by the server. Cloud servers are examples.

According to some embodiments, devices capable of operating as a server (e.g., host servers 108-110 or application server 112) may include, as examples, dedicated rack-mounted servers, desktop computers, laptop computers, set top boxes, integrated devices combining various features, such as two or more features of the foregoing devices, or the like. In some embodiments, host servers 108-110 and/or application server 112 can be a device 1300 as described with respect to FIG. 13.

Moreover, although FIG. 1 illustrates host servers 108-110 and application server 112 as single computing devices, respectively, the disclosure is not so limited. For example, one or more functions of host server host servers 108-110 and/or application server 112 can be distributed across one or more distinct computing devices.

In some embodiments, host servers 108-110 and/or application server 112 can implement devices or engines that are configured to provide a variety of services that include, but are not limited to, email services, instant messaging (IM) services, streaming and/or downloading media services, search services, photo services, web services, social networking services, news services, third-party services, audio services, video services, advertising services, mobile application services, NLP services, or the like. In some embodiments, in addition to application server 112, host servers 108-110 can also be referred to as application servers. In some embodiments, application servers can provide the foregoing services to a user upon the user being authenticated, verified, or identified by the service. In some embodiments, users can access services provided by host servers 108-110 and/or application server 112 via the network 106 using UE 102-104. In some embodiments, application server 112 can implement, in part or in its entirety, an insights engine (e.g., insights engine 202).

In some embodiments, applications, such as, but not limited to, news applications (e.g., Yahoo! Sports®, ESPN®, Huffington Post®, CNN®, and the like), mail applications (e.g., Yahoo! Mail®, Gmail®, and the like), streaming video applications (e.g., YouTube®, Netflix®, Hulu®, iTunes®, Amazon Prime®, HBO Go®, and the like), instant messaging applications, blog, photo or social networking applications (e.g., Facebook®, Twitter®, Instagram®, and the like), web conferencing applications (e.g., BlueJeans®, Zoom®, Skype®, and the like), search applications (e.g., Yahoo!® Search), and the like, can be hosted by host servers 108-110 and/or application server 112. Thus, in some embodiments, application server 112, for example, can store various types of applications and application related information including application data and user profile information (e.g., identifying and behavioral information associated with a user).

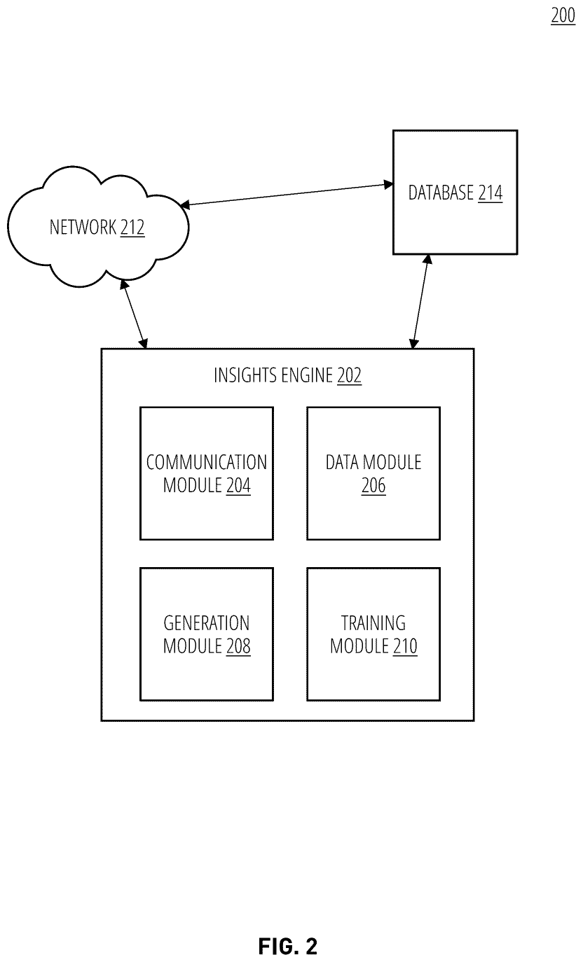

FIG. 2 is a block diagram illustrating components of a natural language (NL) conversation system according to some embodiments.

According to some embodiments, insights system 200 can include insights engine 202, network 212, and database 214. In some embodiments, insights engine 202 can be a special purpose machine or processor and could be hosted by a cloud server (e.g., cloud web services server(s)), messaging server, application server, content server, social networking server, web server, search server, content provider, third party server, user's computing device, and the like, or any combination thereof. In some embodiments, insights engine 202 can be implemented, in part or in its entirety, on application server 112 as discussed in relation to FIG. 1.

According to some embodiments, insights engine 202 can be a stand-alone application that executes on a device (e.g., device 1300 from FIG. 13). In some embodiments, insights engine 202 can function as an application installed on the device, and in some embodiments, such application can be a web-based application accessed by the device (e.g., UE 102-104) over a network (e.g., network 106). In some embodiments, portions of the insights engine 202 can function as an application installed on the device and some other portions can be cloud-based or web-based applications accessed by the computing device over a network (e.g., network 212), where the several portions of the insights engine 202 exchange information over the network (e.g., between host servers 108-110 and/or application server 112). In some embodiments, the insights engine 202 can be installed as an augmenting script, program or application (e.g., a plug-in or extension) to another application or portable data structure.

In some embodiments, the database 214 can be any type of database or memory, and can be associated with a host server or an application server on a network or a computing device. In some embodiments, portions of database 214 can be included in database 114 or be internal to a server or other device.

In some embodiments, a database 214 can include data and/or metadata associated with users, devices, and applications. In some embodiments, such information can be stored and indexed in the database 214 independently and/or as a linked or associated dataset (e.g., using unique identifiers). According to some embodiments, database 214 can store data and metadata associated with messages, images, videos, text, documents, items and services from an assortment of media, applications and/or service providers and/or platforms, and the like. Accordingly, any other type of known or to be known attribute or feature associated with a record, request, data item, media item, website, application, communication, and/or its transmission over a network (e.g., network traffic), content included therein, or some combination thereof, can be saved as part of the data/metadata in database 214.

In some embodiments, database 214 can include MPC data. In some embodiments, MPC data can include audio or video recordings. In some embodiments, recordings included in MPC data can be in any format, known or to be known, without departing from the scope of the present disclosure. In some embodiments, recordings included in MPC data can have associated recording metadata (e.g., date, time, length, size, author, type, format, etc.). In some embodiments, MPC data can be text transcripts of audio or video recordings.

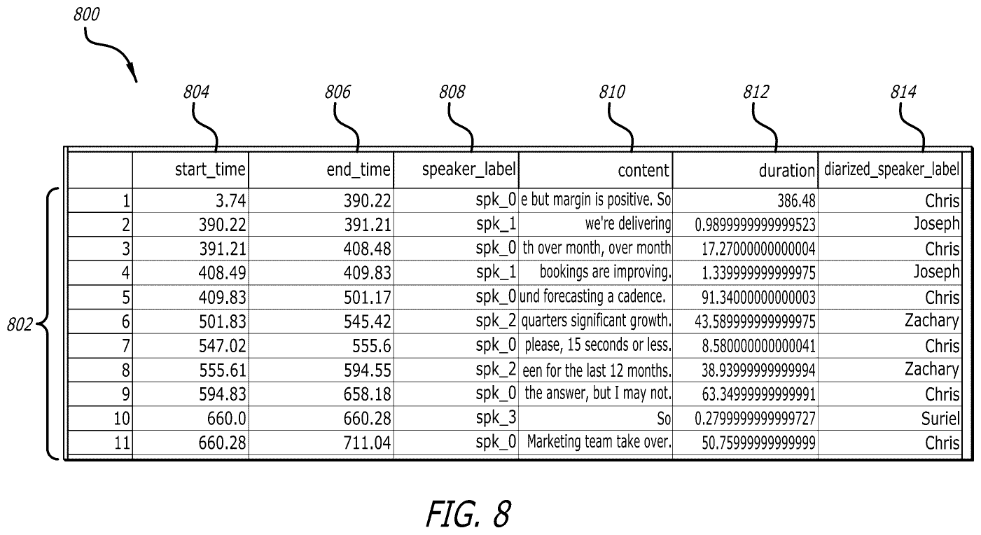

In some embodiments, MPC data can include event timelines corresponding to the MPC recordings. A non-limiting example embodiment of an event timeline is illustrated in FIG. 8. In some embodiments, when the MPC data includes a video recording, the MPC data can include a plurality of discrete video frames or sequence of frames and/or associated audio for each frame or sequence. In some embodiments, MPC data can correlate events with discrete video frames and/or audio snippets.

In some embodiments, MPC data can include speaker separated data (e.g., snippets of audio, video, text, or a combination thereof attributed to individual speakers). In some of those embodiments, MPC data can include one or more discrete audio snippets of the MPC where each audio snippet has an associated speaker or timestamp (e.g., as metadata). In some embodiments, MPC data can include discrete text strings from a chat conversation among two or more speakers. In some embodiments, each discrete text string can correspond to an input or contribution by a speaker or participant. In some embodiments, each discrete text string can have an associated speaker or timestamp (e.g., as metadata).

In some embodiments, MPC data can include annotated MPC data associated with an MPC, MPC recording, event timeline, or a combination thereof. In some embodiments, annotated MPC data can include MPC data that has been labeled or otherwise annotated either manually by a human or automatically by a labeling algorithm. For example, in some embodiments, annotated MPC data can include an MPC summary corresponding to an MPC. In some embodiments, the MPC summary can be based on at least one of manual notes prepared by a human, the MPC recording, and/or an event timeline associated with the meeting. In some embodiments, annotated MPC data can include one or more follow-up items associated with the MPC.

According to some embodiments, network 212 can be any type of network such as, but not limited to, a wireless network, a local area network (LAN), wide area network (WAN), the Internet, or a combination thereof. In some embodiments, network 212 can facilitate connectivity of the insights engine 202, and the database 214. Indeed, as illustrated in FIG. 2, the insights engine 202 and database 214 can be directly connected by any known or to be known method of connecting and/or enabling communication between such devices and resources. In some embodiments, network 212 can include some or all the elements of network 106 as discussed in relation to FIG. 1.

The principal processor, server, or combination of devices that comprise hardware programmed in accordance with the special purpose functions herein is referred to for convenience as insights engine 202, and includes communication module 204, data module 206, generation module 208, and training module 210. It should be understood that the engine(s) and modules discussed herein are non-exhaustive, as additional or fewer engines and/or modules (or sub-modules) may be applicable to the embodiments of the systems and methods discussed. The operations, configurations and functionalities of each module, and their role within embodiments of the present disclosure will be discussed below.

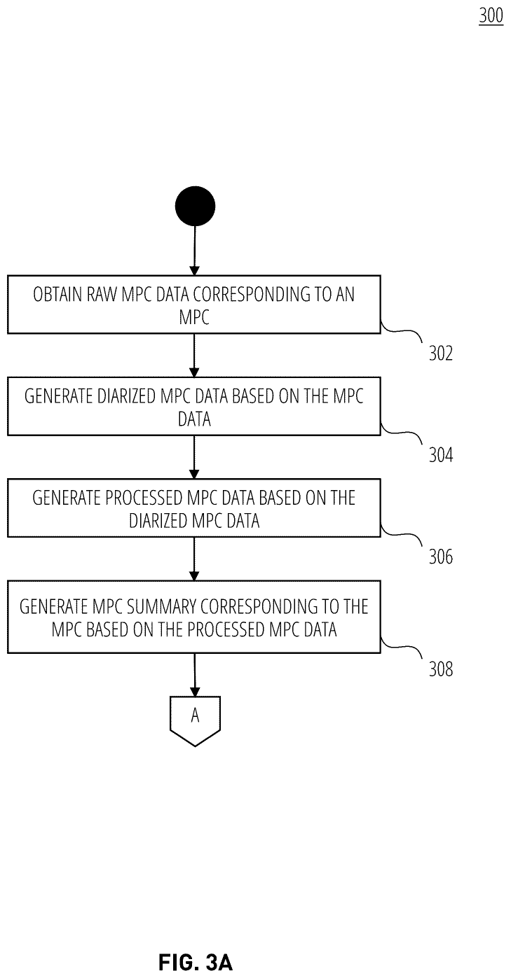

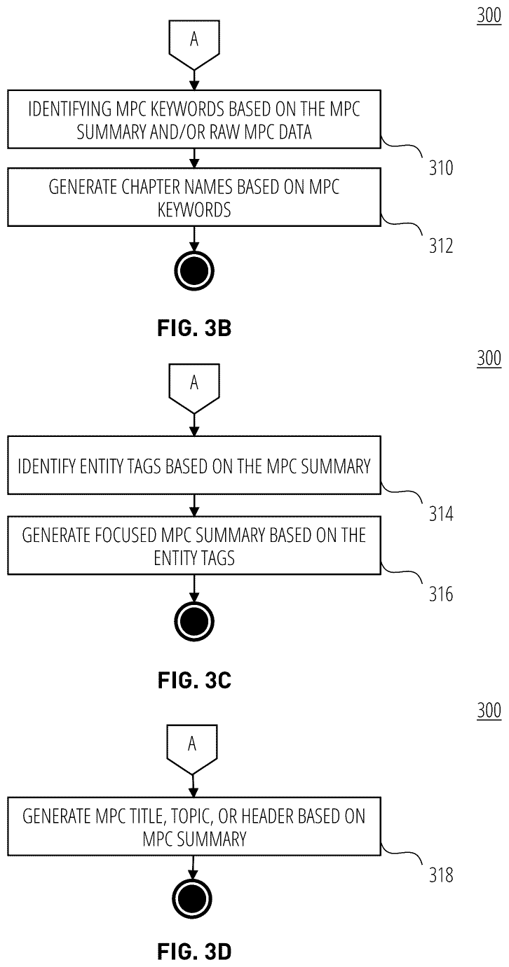

FIG. 3A-FIG. 3D illustrate a flow diagram of a method for generating MPC insights according to an embodiment.

According to some embodiments, method 300 can be performed by insights engine 202. In some embodiments, Steps 302, 310, and 314 can be performed by data module 206 and Steps 304-308, 312, 316, and 318 can be performed by generation module 208, each in communication with the communication module 204 and the training module 210.

In Step 302, method 300 can include obtaining raw MPC data corresponding to an MPC. In some embodiments, the raw MPC data can include a video and/or audio component. In some embodiments, the raw MPC data can also include a text component (e.g., a transcript) of the audio or video. In some embodiments, the raw MPC data can include MPC metadata.

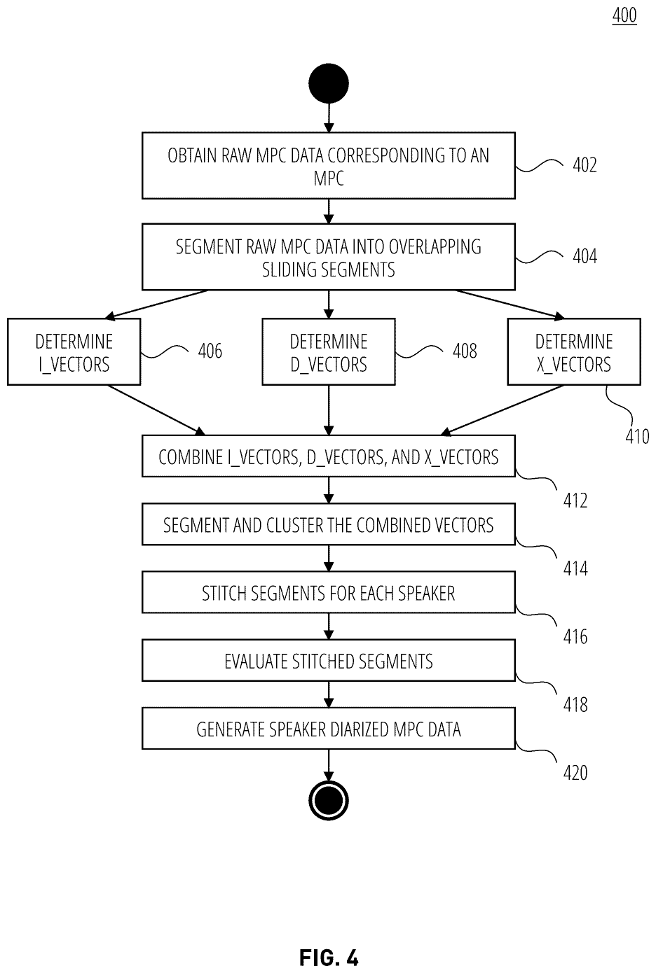

In Step 304, method 300 can include diarizing the raw MPC data to generate diarized MPC data. In some embodiments, generating diarized MPC data can be performed as described with respect to FIG. 4. In some embodiments, the process of diarizing raw MPC data involves segmenting MPC data according to which anonymized speaker or participant is active in the portion of the MPC. In some embodiments, diarized MPC data can include a plurality of segments corresponding to and associated with input by discrete speakers or participants of an MPC. In some embodiments, the true identity of the speaker or participant may not be known at this stage. In some of those embodiments, the associated speaker can be a unique speaker label (e.g., “spk_0” or “Participant 2”). In some embodiments, a speaker can be associated with one or more segments.

In some embodiments, the speaker or participant input can be speaking, appearing on video, sending a message in a chat of an MPC environment, or otherwise participating in the MPC. In some embodiments, each segment can include an audio component, a video component, a text component, and segment metadata. In some embodiments, segment metadata can include start and end times of the segment respective to the overall MPC and/or absolute with respect to standard reference time (e.g., EST), segment length, associated speaker or speaker label, speaker information (e.g., name, address, location, title, unique ID, etc.), a type of content being displayed for the video component (e.g., presentation, other videos), and MPC metadata. In some embodiments, MPC metadata can include the dates and times associated with the MPC, participants, locations, format, overall length. In some embodiments, the segment can also include relevant portions of an event timeline (e.g., event timeline 800) associated with the MPC.

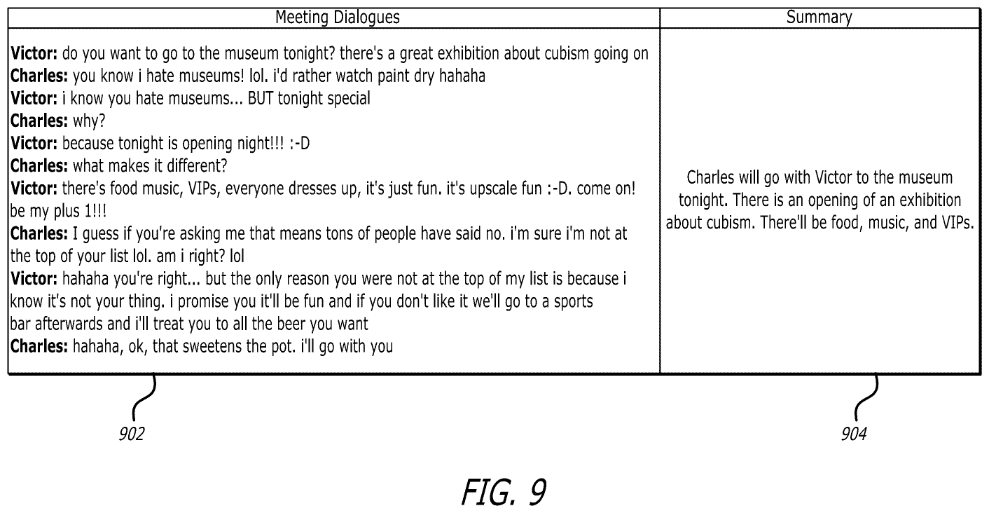

In Step 306, method 300 can include generating processed diarized MPC data from the diarized MPC data. In some embodiments, processing the MPC data can include assigning or identifying the real identity of the speakers identified in the diarized MPC data. That is, in some embodiments, a real participant is identified for each unique speaker label. FIG. 9 illustrates a non-limiting example of processed diarized MPC data in the form of a meeting dialogue 902.

In some embodiments, determining the identity of the speaker can include for each segment identifying a corresponding text transcript of the dialog or input by the speaker associated with that segment and determining which speaker provided input by comparing the text with similar text attributed to the speaker in an event timeline associated with the MPC. For example, as illustrated in FIG. 8, in some embodiments, in processed MPC data, spk_0 can be determined to be Chris while spk_3 is Suriel.

In some embodiments, the segments can be culled to remove short interactions. For example, in some embodiments, segments shorter than a predetermined length can be removed (e.g., less than 1 second). In some embodiments, segments where the text is unintelligible or gabbled can be removed. In some embodiments, segments where the speaker only provided filler language (e.g., “ah”, “uh”) can be removed. In some embodiments, segments where the speaker cursed or spoke words in a predetermined set of filtered words (e.g., violent or indecent language) can be removed.

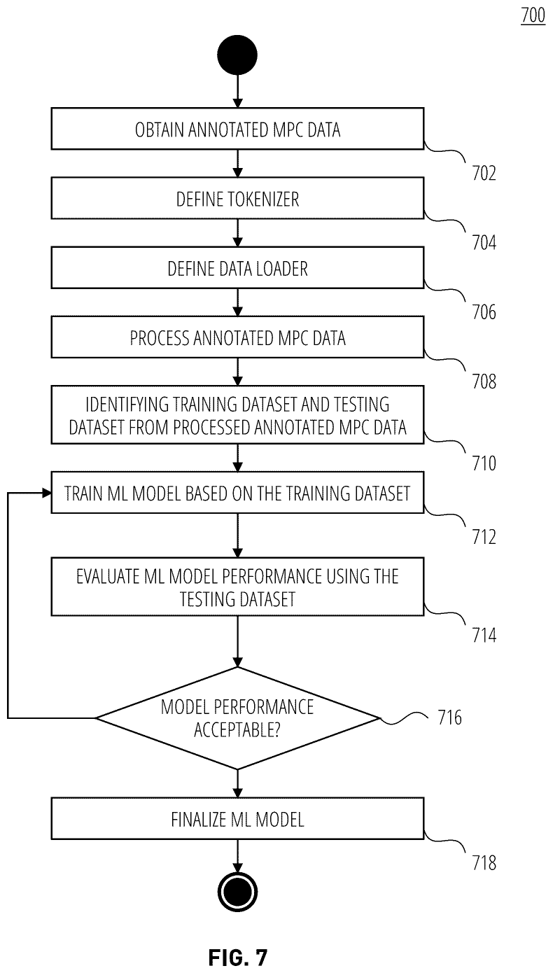

In Step 308, method 300 can include generating an MPC summary based on the processed diarized MPC data. In some embodiments, the MPC summary can be generated by applying a trained summarization model to the processed diarized MPC data. FIG. 9 illustrates a non-limiting example of an MPC summary (e.g., MPC summary 904) based on processed diarized MPC data (e.g., meeting dialogue 902). FIG. 10 illustrates a non-limiting example rendering 1000 including an MPC summary 1006. In some embodiments, the trained summarization model can be generated as described in relation to FIG. 7. In some embodiments, the MPC Summary can be used to generate MPC insights as described in Steps 310-318.

In some embodiments, a summarization model can be a machine learning model with a transformer based architecture such as the Bidirectional and Auto-Regressive Transformers (BART) architecture. In some embodiments, the summarization model can be any transformer based architecture suitable for NLP including, but not limited to, for example, BERT, a Generative Pretrained Transformer (GPT) architecture, a Robustly Optimized BERT Approach (ROBERTa) architecture, an Electra architecture, or a Text-to-Text Transfer Transformer (T5) architecture.

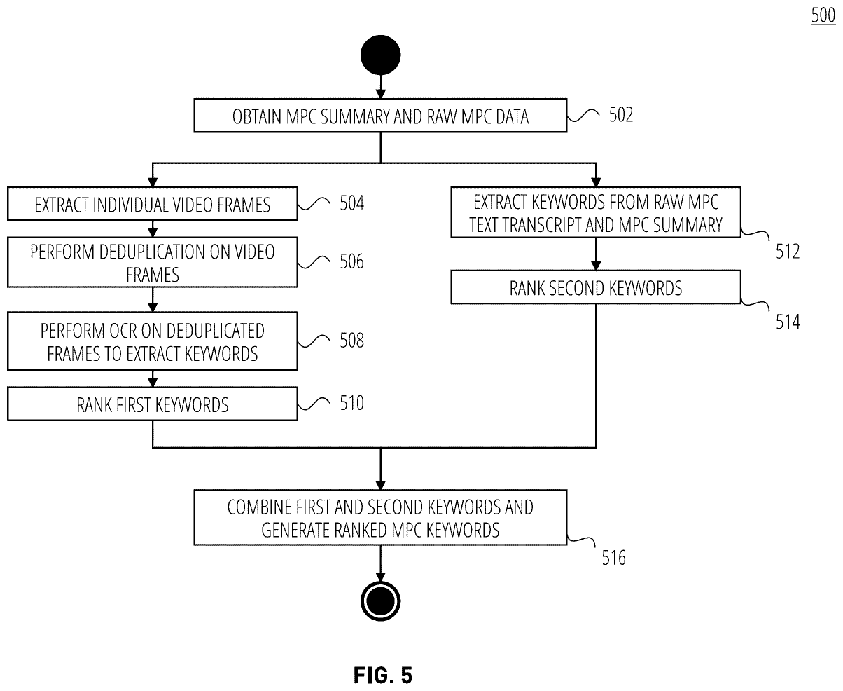

In Step 310, method 300 can include identifying MPC keywords based on the MPC summary and/or the raw MPC data. In some embodiments, the MPC keywords can be identified based on the MPC summary and the raw MPC data. In some embodiments, the MPC keywords can be a ranked list of keywords. FIG. 5 illustrates a non-limiting example of a method for identifying and ranking MPC keywords.

In some embodiments, the MPC keywords can be identified by applying a trained keyword model to the MPC summary and/or the raw MPC data. In some embodiments, the trained keyword model can be a machine learning model including a transformer based architecture (e.g., KeyBERT). In some embodiments, the MPC keywords can be identified by applying a keyword tool such as GENSIM to the MPC summary and/or raw MPC data to obtain the MPC keywords. In some embodiments, the MPC keywords can be identified by applying a XSUM-based algorithm to the MPC summary and/or the raw MPC data. In some embodiments, the MPC keywords can be ranked using a Term Frequency-Inverse Document Frequency (TF-IFD) algorithm. In some embodiments, prior to ranking the MPC keywords, the MPC keywords can be culled to remove any non-noun terms.

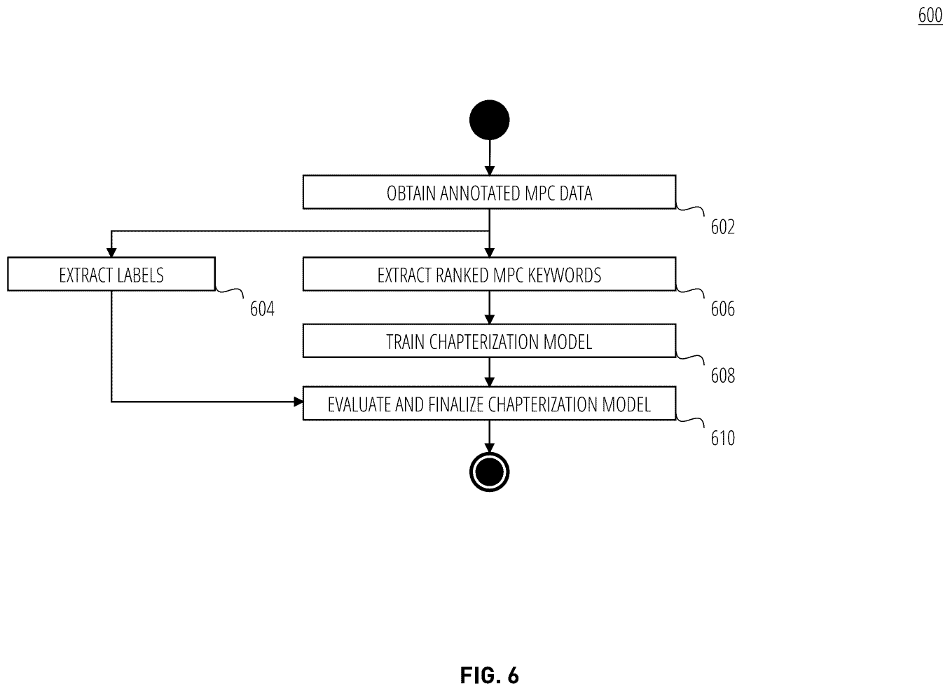

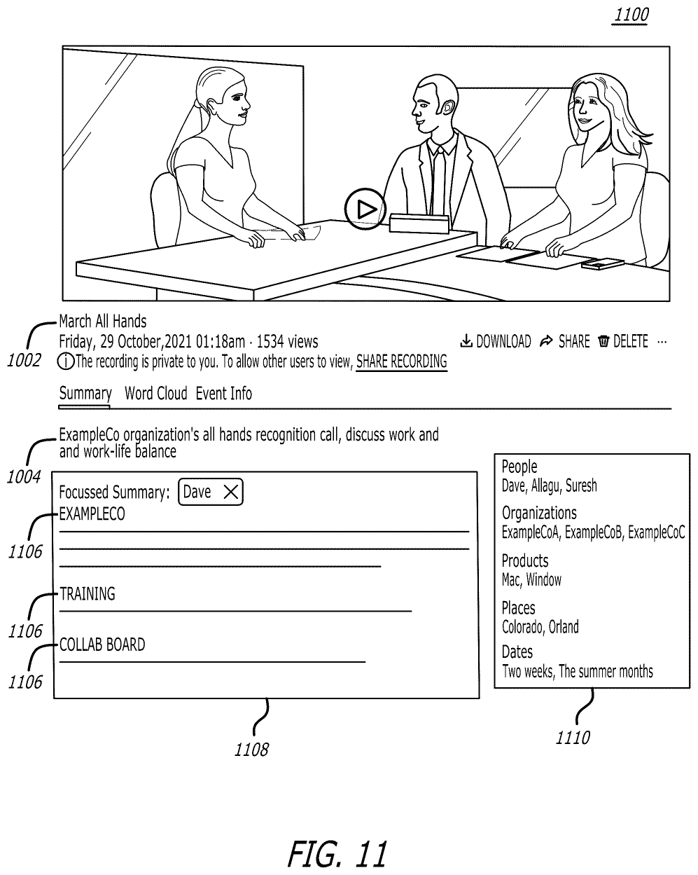

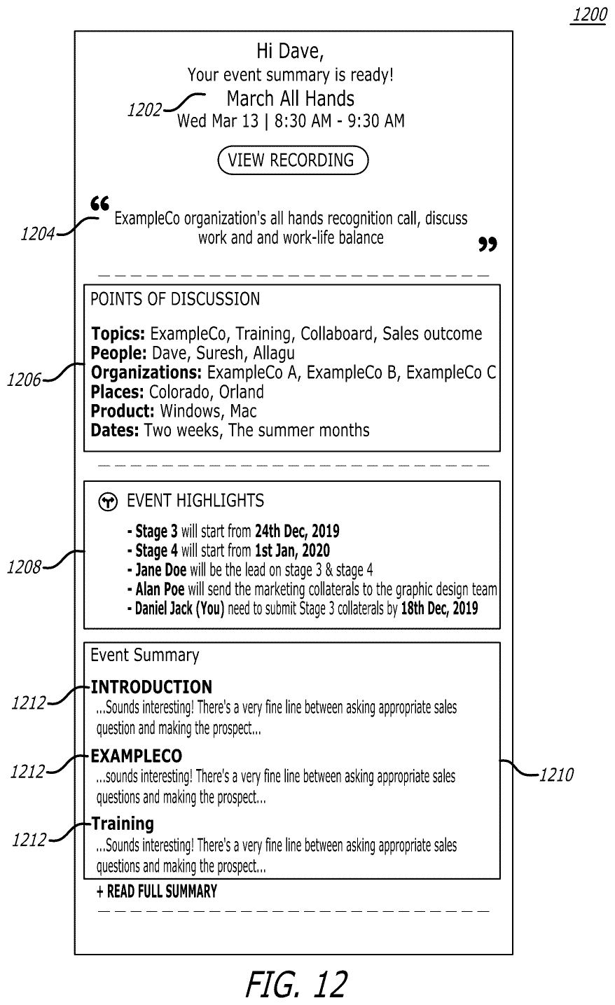

In Step 312, method 300 can include generating MPC chapter names based on the MPC keywords, the MPC summary, and/or the raw MPC data. In some embodiments, the MPC chapter names can be generated by applying a trained chapterization model to the MPC keywords. In some embodiments, the MPC chapter names correspond to logical content segments of the MPC. Non-limiting examples of MPC chapter names are illustrated as part of rendering 1000, rendering 1100, and rendering 1200 in FIG. 10 (e.g., MPC chapter names 1010), FIG. 11 (e.g., MPC chapter names 1106), and FIG. 12 (e.g., MPC chapter names 1212), respectively. In some embodiments, the trained chapterization model can be trained as described in relation to FIG. 6.

In Step 314, method 300 can include identifying relevant entities from the MPC summary. In some embodiments, a relevant entity can be a person, location, company, numeric value, product, date/time, or other entity important to an organization. Non-limiting examples of relevant entities are illustrated as part of rendering 1000, rendering 1100, and rendering 1200 in FIG. 10 (e.g., relevant entities 1008), FIG. 11 (e.g., relevant entities 1110), and FIG. 12 (e.g., relevant entities 1206), respectively.

In some embodiments, the relevant entities can be determined by applying a trained entity model to the MPC summary. In some embodiments, the entity model can be a machine learning model including a BERT architecture. In some embodiments, the entity model can be a machine learning model based on the Flair framework. In some embodiments, the trained entity model can be generated as described in relation to FIG. 7.

In Step 316, method 300 can include generating focused MPC summary with respect to one or more of the relevant entities. For example, the focused MPC summary can correspond to a specific person, product, or place. A non-limiting example of a focused MPC summary is illustrated as part of rendering 1100 in FIG. 11 (e.g., focused MPC summary 1108).

In some embodiments, the focused MPC summary can be generated by applying a trained focused summarization model to the identified relevant entities. In some embodiments, the focused summarization model can be a machine learning model including a transformer-based architecture such as BART. In some embodiments, the focused summarization model can be trained as described in relation to FIG. 7.

In Step 318, method 300 can include generating a title, topic, or header for the MPC based on the MPC summary and/or the raw MPC data. In some embodiments, the MPC title, topic, or header can be generated by applying a trained header model. In some embodiments, the trained header model can be a machine learning model including a transformer-based architecture such as BART or BERT. In some embodiments, the header model can be trained as described in relation to FIG. 7. In some embodiments, the trained header model can be specific to generating titles, headers, or topics based on the annotated MPC data used to train the header model. Non-limiting examples of titles, topics, and headers are shown in FIG. 10 (e.g., title 1002, MPC header 1004), FIG. 11 (e.g., title 1102, MPC header 1104), and FIG. 12 (e.g., title 1202, MPC header 1204).

FIG. 4 is a flow diagram illustrating a method for generating diarized MPC data according to an embodiment.

According to some embodiments, method 400 can be performed by insights engine 202. In some embodiments, Steps 402, 404, 412-420 can be performed by data module 206 and Steps 406-410, can be performed by generation module 208, each in communication with the communication module 204 and the training module 210.

In Step 402, method 400 can include obtaining raw MPC data corresponding to an MPC. In some embodiments, the raw MPC data can include a video and/or audio component. In some embodiments, the raw MPC data can also include a text component (e.g., a transcript) of the audio or video. In some embodiments, the raw MPC data can include MPC metadata.

In Step 404, method 400 can include segmenting and processing the video and/or video component of the raw MPC data. In some embodiments, the audio component of raw MPC data can be segmented into overlapping sliding windows or segments. In some embodiments, each segment can have predetermined length (e.g., milliseconds, seconds). In some embodiments, the segments can overlap a predetermined length (e.g., milliseconds, seconds). In some embodiments, each segment can have a corresponding text component (e.g., transcript). In some embodiments, each segment can be processed to generate a processed segment by determining the features of the audio component in the segment. In some embodiments, the audio features can include attributes associated with the frequency spectrum (e.g., spectral features) such as the spectral centroid, spectral flux, spectral roll-off, and the Mel Frequency Cepstral Coefficients (MFCCs). In some embodiments, the audio features can include attributes of the audio signal in the time domain such as Zero Crossing Rate (ZCR), amplitude envelope, and Root Mean Square (RMS).

In Step 406, method 400 can include analyzing one or more of the processed segments (including the features) to determine the corresponding identity vectors (e.g., i_Vectors) in the segment. In some embodiments, i_Vectors can represent a part of speech by a speaker in a fixed-length low-dimensional feature vector. In some embodiments, the i_Vectors can be determined by applying a trained Gaussian Mixture Model (GMM) or some other trained probabilistic model to the processed segment.

In Step 408, method 400 can include analyzing one or more of the processed segment (including the features) to determine the corresponding deep vectors (e.g., d_Vectors) in the segment. In some embodiments, d_Vectors can represent a part of speech by a speaker in a fixed-length low-dimensional feature vector similar to i_Vectors but determined using different techniques. For example, in some embodiments, the d_Vectors can be determined by applying a trained d_Vector model including an ML model such as a Multilayer Perceptron model, a Long Short-Term Memory (LSTM) model, a Convolutional Neural Network (CNN) model, or a Transformer-based model. In some embodiments, the d_Vectors model can be trained can be trained as described in relation to FIG. 7.

In Step 410, method 400 can include analyzing one or more of the processed segment (including the features) to determine the corresponding x_Vectors in the segment. In some embodiments, x_Vectors can represent a part of speech by a speaker in a fixed-length low-dimensional feature vector similar i_Vectors and d_Vectors. For example, in some embodiments, the x_Vectors can be determined by applying a trained x_Vector model similar to the d_Vector models (e.g., including an ML model such as a Multilayer Perceptrons model, a Long Short-Term Memory (LSTM) model, a Convolutional Neural Network (CNN) model, or a Transformer-based model). However, in some embodiments, the x_Vectors model may be trained in different datasets such as the National Institute of Standards and Technology (NIST) datasets.

In Step 412, method 400 can include combining the i_Vectors, the d_Vectors, and the x_Vectors for each processed segment. In some embodiments, combining the vectors can include concatenating the vectors into a combined vector for each processed segment.

In Step 414, method 400 can include segmenting and clustering the combined vectors into an N number of speakers. In some embodiments, clustering can be achieved using a clustering algorithm such as K-means clustering, spectral clustering, hierarchical clustering, or any other suitable clustering algorithm. In some embodiments, N can correspond to the total number of speakers that participated in the MPC. In some embodiments, the number of speakers can be determined from MPC metadata included in the raw MPC data obtained in Step 402. In Step 414, method 400 can include assigning an anonymized speaker label to each cluster.

In Step 416, method 400 can include stitching together the segments corresponding to each speaker to generate stitched segments. In some embodiments, the stitched segments can be generated by selecting the segments associated with each speaker and editing them into a continuous stream.

In Step 418, method 400 can include evaluating the stitched segments to determine inconsistencies (e.g., incorrectly attributed segments) in the stitched segments. For example, in some embodiments, evaluating the stitched segments can include determining a Diarization Error Rate (DER).

In Step 420, method 400 can include generating diarized MPC data corresponding to the MPC. In some embodiments, diarized MPC data can include the stitched segments or individual segments for each speaker, each with associated segment metadata.

FIG. 5 is a flow diagram illustrating a method for generating MPC keywords according to an embodiment.

According to some embodiments, method 500 can be performed by insights engine 202. In some embodiments, Steps 502-516 can be performed by data module 206 in communication with the communication module 204 and the training module 210.

In Step 502, method 500 can include an MPC summary and/or raw MPC data corresponding to an MPC. In some embodiments, the MPC summary can be the MPC summary generated as described in FIG. 3A. In some embodiments, the raw MPC data can include a video and/or audio component. In some embodiments, the raw MPC data can also include a text component (e.g., transcript) of the audio or video. In some embodiments, the raw MPC data can include MPC metadata including an event timeline (e.g., event timeline 800). In some embodiments, the MPC summary can have a text component.

In Step 504, method 500 can include extracting the video component of the raw MPC data and identifying the discrete video frames in the video component. In some embodiments, video frames can be identified based on transition between frames.

In Step 506, method 500 can include performing deduplication in the identified video frames to remove any duplicate frames. In some embodiments, deduplication can be performed using an image gradients-based hashing.

In Step 508, method 500 can include performing Optical Character Recognition (e.g., OCR) to identify any text in each of the resulting deduplicated frame from Step 506. In some embodiments, any suitable OCR technique may be employed. In some embodiments, the identified text is parsed into terms or keyword. In some embodiments, method 500 can also include determining a frequency for each keyword. In some embodiments, the extracted text is combined into a list of video keywords and associated frequencies.

In Step 510, method 500 can include ranking the list of video keywords to generate a ranked list of first keywords. In some embodiments, ranking the list of video keywords can include ranking the words based on density and size (e.g., frequency). In some embodiments, the list of video keywords can be ranked using a Term Frequency-Inverse Document Frequency (TF-IDF) technique or any other suitable ranking technique. In some embodiments, prior to ranking the video keywords, the video keywords can be culled to remove any non-noun terms.

In Step 512, method 500 can include extracting one or more transcript keywords from the raw MPC data and/or the MPC summary. In some embodiments, the trained keywords can be extracted by combining and parsing the MPC Summary and the raw MPC data.

In some embodiments, the transcript keywords can be identified by applying a trained keyword model to the MPC summary and/or raw MPC data. In some embodiments, the trained keyword model can be a machine learning model including a transformer based architecture (e.g., KeyBERT). In some embodiments, the transcript keywords can be identified by applying a keyword tool such as GENSIM to the MPC summary and/or raw MPC data. In some embodiments, the transcript keywords can be identified by applying a XSUM-based algorithm to the MPC summary and/or the raw MPC data.

In Step 514, method 500 can include ranking the list of transcript keywords to generate a ranked list of second keywords. In some embodiments, the transcript keywords can be ranked using a Term Frequency-Inverse Document Frequency (TF-IFD) technique or any other suitable technique. In some embodiments, prior to ranking the transcript keywords, the transcript keywords can be culled to remove any non-noun terms.

In Step 516, method 500 can include combining the first keywords and the second keywords can be combined and compared to determine the most relevant keywords. In some embodiments, the selected relevant keywords are compiled into a ranked list of MPC keywords. In some embodiments, relevant keywords can be selected based on a predetermined threshold (e.g., the top 10 keywords). In some embodiments, the first and second key words can be provided to a ranking model to determine the relevant keywords. In some embodiments, the ranking model can be a BART-architecture based model.

FIG. 6 is a flow diagram illustrating a method for generating a trained chapterization model according to an embodiment.

According to some embodiments, method 600 can be performed by insights engine 202. In some embodiments, Step 602-606 and can be performed by data module 206 and Steps 608-610 in communication with the communication module 204 and the training module 210.

In Step 602, method 600 can include obtaining annotated MPC data corresponding to an MPC. In some embodiments, annotated MPC data can include a video and/or audio component. In some embodiments, the annotated MPC data can include a text component (e.g., transcript) of the audio or video. In some embodiments, the annotated MPC data can include MPC metadata including an event timeline (e.g., event timeline 800). In some embodiments, the annotated MPC data can include an MPC summary with a text component. In some embodiments, the annotated MPC data can include a plurality of labels or annotations provided by human reviewers. In some embodiments, annotated MPC data can include off-the-shelf datasets.

In Step 604, method 600 can include extracting the labels or annotations ascribed to the audio, video, and/or text components and/or the MPC summary. In some embodiments, the extracted can be used to evaluate the performance of the chapterization model in Step 610.

In Step 606, method 600 can include extracting MPC keywords from the annotated MPC data. In some embodiments, extracting the MPC keywords can be accomplished through method 500 as described in FIG. 5.

In Step 608, method 600 can include training the chapterization model using the MPC keywords. In some embodiments, training the chapterization model can further include initializing the model (e.g., by assigning small, random values to the model's weights or by using pre-trained weights); tokenizing and masking the training data; predicting the masked tokens; calculating a loss based on the actual values of the removed tokens; and updating the model's parameters (e.g., weights). In some embodiments, the chapterization model can a be ML model including a transformer-based architecture such as BART.

In Step 610, method 600 can include evaluating the chapterization model's performance using the extracted labels from Step 604. In some embodiments, the chapterization model's performance can be evaluated by determining embedding based distance metrics between the model's output and the extracted labels. In some embodiments, if the model's performance is acceptable the model is finalized.

FIG. 7 is a flow diagram illustrating a method for generating a trained machine learning (ML) model according to an embodiment.

In Step 702, method 700 can include obtaining MPC data corresponding to an MPC. In some embodiments, MPC data can be annotated MPC data. In some embodiments, the data module 206 of insights system 200 can retrieve the annotated MPC data from a database (e.g., database 214).

In some embodiments, annotated MPC data can be specific to the ML model being trained. In some embodiments, annotated MPC data can be MPC data with annotations provided by human reviewers. In some embodiments, annotated MPC data can include off-the-shelf datasets. For example, in some embodiments, annotated MPC data used for training a summarization model can include off-the-shelf datasets such as the ARXIV dataset, the BigPatent dataset, and the BillSum dataset. As another example, in some embodiments, annotated MPC data used for training a header model can include off-the-shelf datasets such as the DialogSUM dataset and the XSUM dataset. In some embodiments, annotated MPC data can include data from publicly available social media datasets (e.g., CNN®, the Daily Mail®) or other datasets such as the AMI Meeting Corpus and the SAMSUM dataset.

In Step 704, method 700 can include defining a tokenizer for the specific model being trained. In some embodiments, the tokenizer can convert MPC data or annotated MPC data into a data format suitable for training an ML mode. In some embodiments, a tokenizer converts text data into numerical data. In some embodiments, the data module 206 of insights system 200 can select and implement a tokenizer based on the type of ML model being trained. For example, in some embodiments, to train a BART or BERT architecture-based model, training module 210 can implement the WordPiece tokenizer. In some embodiments, the tokenizer can be any tokenizer used for training BART or BERT architecture-based models.

In Step 706, method 700 can include defining a data loader. In some embodiments, the data module 206 can implement the data loader to manage the annotated MPC data as it is processed and passed to the ML model during training by the training module 210. In some embodiments, a data loader can be an off-the-shelf data loader such as the PyTorch DataLoader or the TensorFlow® data loader.

In Step 708, method 700 can include processing the annotated MPC data in preparation for training the ML model. In some embodiments, Step 708 can be performed by data module 206. In some embodiments, processing the annotated MPC data can include cleaning the data (e.g., address missing values, remove duplicates, etc.), normalizing or scaling the data, and augmenting the data. In some embodiments, the output of Step 708 is processed annotated MPC data.

In Step 710, method 700 can include identifying a training dataset and a testing dataset from the processed annotated MPC data. In some embodiments, the training dataset can be used to train the model while the testing dataset can be used to evaluate the model's performance. In some embodiments, a third dataset-a validation dataset—can also be used during training to tune hyperparameters and make decisions on the training process. In some embodiments, the processed annotated MPC data can be split by the data module 206 based on predetermined ratios (e.g., 80% as training data, 20% as testing data). In some embodiments, data module 206 can shuffle or randomize the processed annotated MPC data prior to identifying the training and testing datasets.

In Step 712, method 700 can include training the ML model. In some embodiments, the training process can be performed by training module 210. As noted above, in some embodiments, the ML model can be the command recognition model, the summarization model, and the tone/style transfer model. In some embodiments, training the ML model can include initializing the model (e.g., by assigning small, random values to the model's weights or by using pre-trained weights); tokenizing then data in the training dataset using the tokenizer defined in Step 704; masking some of the tokens at random; making predictions for the masked tokens; calculating a loss based on the actual values of the removed tokens; and updating the model's parameters (e.g., weights). In some embodiments, these operations can be repeated until the model's performance on the training dataset or a validation dataset stabilizes or stops improving.

In Step 714, method 700 can include evaluating the ML model's performance using the testing dataset. In some embodiments, training module 210 can evaluate the model's performance by comparing the model's performance to a set of predetermined metrics. For example, in some embodiments, the predetermined metrics can be the ROUGE-1, ROUGE-2, or ROUGE-L evaluation metrics.

In Step 716, method 700 can include determining whether the ML model's performance is acceptable based on the results of the model's evaluation in Step 714. In some embodiments, if training module 210 determines that the model's performance is acceptable, then training module 210 finalizes the model in Step 718. If the model's performance is not acceptable then training module 210 repeats some or all of the training process. In some embodiments, the result of Step 718 is a trained ML model (e.g., a trained header model, a trained summarization model, a trained entity model, or a trained focused summarization model).

FIG. 8 illustrates an example event timeline according to some embodiments.

In some embodiments, an event timeline 800 can include a one or more events 802 and event data (804-814) for each event 802. In some embodiments, event data can include a start time 804, an end time 806, a duration 812, a content 810, a speaker label 808, or a diarized speaker label 814 indicating a speaker or participant associated with the speaker label 808.

In some embodiments, for a given event 802, content 810 can include an input or contribution by the corresponding speaker or participant (e.g., as denoted by speaker label 808 or content 810). In some embodiments, as shown in FIG. 8, the contribution can be spoken words by the speaker. In some embodiments, the contribution can be a gesture or expression by the speaker and the content can be a description of the contribution. In some embodiments, the contribution can be a string of text entered into a chat. In some embodiments, the contribution can be a digital item (e.g., emoji, picture, video, audio, presentation, document). In some of those embodiments, the content 810 can include a description of the contribution (e.g., “spk_0/Chris has sent a smiling emoji”).

FIG. 9 illustrates an example MPC summary according to some embodiments.

In some embodiments, MPC summary 904 is a summary of a meeting dialogue 902. In some embodiments, MPC summary 904 represents the content of the meeting dialogue 902. In some embodiments, meeting dialogue 902 is a non-limiting example of processed diarized MPC data.

FIG. 10 illustrates an example of a graphical rendering 1000 comprising MPC insights according to an embodiment.

Rendering 1000 illustrates MPC insights including an MPC title 1002 given to or generated for an MPC and an MPC header 1004 (e.g., a brief sentence summarizing the contents of the MPC). Rendering 1000 further illustrates an MPC summary 1006 including MPC chapter names 1010 and relevant entities 1008 such as “People,” “Organizations,” “Products,” “Places,” and “Dates.”

FIG. 11 illustrates another example of a graphical rendering 1100 comprising MPC insights according to an embodiment.

As shown, rendering 1100 is similar to rendering 1000 illustrated in FIG. 10 except that the MPC summary 1006 is replaced by a focused MPC summary 1108. As noted elsewhere, in some embodiments, a focused MPC summary (e.g., focused MPC summary 1108) can be specific to a user and can include MPC chapter names 1106 as well as short narratives specific to the user or to topics relevant to the user. Rendering 1100 also illustrates MPC title 1102. MPC header 1104, and relevant entities 1110 similar to rendering 1000.

FIG. 12 illustrates another example of a graphical rendering 1200 comprising MPC insights according to an embodiment.

As shown, rendering 1200 presents the MPC insights in a different format than rendering 1000 or rendering 1100. Similar to FIG. 10 and FIG. 11. FIG. 12 illustrates an MPC title 1202, an MPC header 1204, and relevant entities 1206. rendering 1200 further illustrates MPC highlights (e.g., MPC highlights 1208) and a shortened version of an MPC summary (e.g., shortened MPC summary 1210) including MPC chapter names 1212. In some embodiments, the application displaying the MPC insights can enable the user to expand the shortened MPC summary 1210 to see the full MPC summary.

FIG. 13 is a block diagram of a device according to some embodiments.

As illustrated, the device 1300 can include a processor or central processing unit (CPU) such as CPU 1302 in communication with a memory 1304 via a bus 1314. Device 1300 can also include one or more input/output (I/O) or peripheral devices 1312. Examples of peripheral devices include, but are not limited to, network interfaces, audio interfaces, display devices, keypads, mice, keyboard, touch screens, illuminators, haptic interfaces, global positioning system (GPS) receivers, cameras, or other optical, thermal, or electromagnetic sensors.

In some embodiments, the CPU 1302 can comprise a general-purpose CPU. The CPU 1302 can comprise a single-core or multiple-core CPU. The CPU 1302 can comprise a system-on-a-chip (SoC) or a similar embedded system. In some embodiments, a graphics processing unit (GPU) can be used in place of, or in combination with, a CPU 1302. Memory 1304 can comprise a non-transitory memory system including a dynamic random-access memory (DRAM), static random-access memory (SRAM), Flash (e.g., NAND Flash), or combinations thereof. In one embodiment, the bus 1314 can comprise a Peripheral Component Interconnect Express (PCIe) bus. In some embodiments, bus 1314 can comprise multiple busses instead of a single bus.

Memory 1304 illustrates an example of non-transitory computer storage media for the storage of information such as computer-readable instructions, data structures, program modules, or other data. Memory 1304 can store a basic input/output system (BIOS) in read-only memory (ROM), such as ROM 1308, for controlling the low-level operation of the device. The memory can also store an operating system in random-access memory (RAM) for controlling the operation of the device

Applications 1310 can include computer-executable instructions which, when executed by the device, perform any of the methods (or portions of the methods) described previously in the description of the preceding Figures. In some embodiments, the software or programs implementing the method embodiments can be read from a hard disk drive (not illustrated) and temporarily stored in RAM 1306 by CPU 1302. CPU 1302 may then read the software or data from RAM 1306, process them, and store them in RAM 1306 again.

The device 1300 can optionally communicate with a base station (not shown) or directly with another computing device. One or more network interfaces in peripheral devices 1312 are sometimes referred to as a transceiver, transceiving device, or network interface card (NIC).

An audio interface in peripheral devices 1312 produces and receives audio signals such as the sound of a human voice. For example, an audio interface may be coupled to a speaker and microphone (not shown) to enable telecommunication with others or generate an audio acknowledgment for some action. Displays in peripheral devices 1312 may comprise liquid crystal display (LCD), gas plasma, light-emitting diode (LED), or any other type of display device used with a computing device. A display may also include a touch-sensitive screen arranged to receive input from an object such as a stylus or a digit from a human hand.

A keypad in peripheral devices 1312 can comprise any input device arranged to receive input from a user. An illuminator in peripheral devices 1312 can provide a status indication or provide light. The device can also comprise an input/output interface in peripheral devices 1312 for communication with external devices, using communication technologies, such as USB, infrared, Bluetooth™, or the like. A haptic interface in peripheral devices 1312 can provide a tactile feedback to a user of the client device.

A GPS receiver in peripheral devices 1312 can determine the physical coordinates of the device on the surface of the Earth, which typically outputs a location as latitude and longitude values. A GPS receiver can also employ other geo-positioning mechanisms, including, but not limited to, triangulation, assisted GPS (AGPS), E-OTD, CI, SAI, ETA, BSS, or the like, to further determine the physical location of the device on the surface of the Earth. In some embodiments, a GPS receiver can determine the physical coordinates of the device via the Global Positioning System (GPS) receiver, GNSS (Global Navigation Satellite System), IEEE Precise Time Protocol (PTP), or other suitable timing reference and position protocol. In one embodiment, however, the device may communicate through other components, providing other information that may be employed to determine the physical location of the device, including, for example, a media access control (MAC) address, Internet Protocol (IP) address, or the like.

The device can include more or fewer components than those shown in FIG. 13, depending on the deployment or usage of the device. For example, a server computing device, such as a rack-mounted server, may not include audio interfaces, displays, keypads, illuminators, haptic interfaces, Global Positioning System (GPS) receivers, or cameras/sensors. Some devices may include additional components not shown, such as graphics processing unit (GPU) devices, cryptographic co-processors, artificial intelligence (AI) accelerators, or other peripheral devices.

The subject matter disclosed above may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, the subject matter may be embodied as methods, devices, components, or systems. Accordingly, embodiments may, for example, take the form of hardware, software, firmware, or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in an embodiment” as used herein does not necessarily refer to the same embodiment, and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms such as “and,” “or,” or “and/or,” as used herein may include a variety of meanings that may depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein, depending at least in part upon context, may be used to describe any feature, structure, or characteristic in a singular sense or may be used to describe combinations of features, structures, or characteristics in a plural sense. Similarly, terms, such as “a,” “an,” or “the,” again, can be understood to convey a singular usage or to convey a plural usage, depending at least in part upon context. In addition, the term “based on” may be understood as not necessarily intended to convey an exclusive set of factors and may, instead, allow for the existence of additional factors not necessarily expressly described, again, depending at least in part on context.

The present disclosure is described with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general-purpose computer to alter its function as detailed herein, a special purpose computer, application-specific integrated circuit (ASIC), or other programmable data processing apparatus, such that the instructions, which execute via the processor of the computer or other programmable data processing apparatus, implement the functions/acts specified in the block diagrams or operational block or blocks. In some alternate implementations, the functions or acts noted in the blocks can occur out of the order noted in the operational illustrations. For example, two blocks shown in succession can, in fact, be executed substantially concurrently, or the blocks can sometimes be executed in the reverse order, depending upon the functionality or acts involved.

These computer program instructions can be provided to a processor of a general-purpose computer to alter its function to a special purpose; a special purpose computer; ASIC; or other programmable digital data processing apparatus, such that the instructions, which execute via the processor of the computer or other programmable data processing apparatus, implement the functions or acts specified in the block diagrams or operational block or blocks, thereby transforming their functionality in accordance with embodiments herein.

For the purposes of this disclosure, a computer-readable medium (or computer-readable storage medium) stores computer data, which data can include computer program code or instructions that are executable by a computer, in machine-readable form. By way of example, and not limitation, a computer-readable medium may comprise computer-readable storage media for tangible or fixed storage of data or communication media for transient interpretation of code-containing signals. Computer-readable storage media, as used herein, refers to physical or tangible storage (as opposed to signals) and includes without limitation volatile and non-volatile, removable, and non-removable media implemented in any method or technology for the tangible storage of information such as computer-readable instructions, data structures, program modules or other data. Computer-readable storage media includes, but is not limited to, RAM, ROM, EPROM, EEPROM, flash memory or other solid-state memory technology, CD-ROM, DVD, or other optical storage, magnetic cassettes, magnetic tape, magnetic disk storage, or other magnetic storage devices, or any other physical or material medium which can be used to tangibly store the desired information or data or instructions and which can be accessed by a computer or processor.

For the purposes of this disclosure, a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer-readable medium for execution by a processor. Modules may be integral to one or more servers or be loaded and executed by one or more servers. One or more modules may be grouped into an engine or an application.

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than or more than all the features described herein are possible.

Functionality may also be, in whole or in part, distributed among multiple components, in manners now known or to become known. Thus, a myriad of software, hardware, and firmware combinations are possible in achieving the functions, features, interfaces, and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example to provide a complete understanding of the technology. The disclosed methods are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure.

What is claimed is:

1. A method comprising:
obtaining multi-party communication (MPC) data corresponding to an MPC, the MPC data comprising an audio component and an event timeline;
generating diarized MPC data based on the MPC data by segmenting the audio component and assigning an anonymized speaker label to each segment;
generating processed diarized MPC data by identifying the speaker corresponding to the anonymized speaker label based on the event timeline;
applying a summarization model to the processed diarized MPC data to generate an MPC summary; and
determining an MPC insight corresponding to the MPC based on the MPC summary and the MPC data.

2. The method of claim 1, further comprising generating the diarized MPC data by:
segmenting the audio component of the MPC data into overlapping segments;
determining at least two of an i_Vector, a d_Vector, and an x_Vector for each segment;
combining the at least two vectors for each segment;
clustering the combined vectors into an N-number of clusters, the N-number of segments corresponding to a number of speakers associated with the MPC; and
assigning the anonymized speaker label to each cluster.

3. The method of claim 1, wherein the MPC insight is a set of MPC keywords, the method further comprising determining the MPC insight by:
extracting a plurality of video frames from a video component of the MPC data;
deduplicating the video frames to obtain unique frames;
performing Optical Character Recognition (OCR) on each unique frame to obtain a plurality of keywords; and
generating the set of MPC keywords by ranking the plurality of keywords.

4. The method of claim 3, further comprising ranking the plurality of keywords using a Term Frequency-Inverse Document Frequency (TF-IDF) technique.

5. The method of claim 3, wherein the MPC insight is a set of MPC chapter names, the method further comprising determining the MPC insight by applying a chapterization model to the MPC keywords.

6. The method of claim 5, wherein the chapterization model includes a Bidirectional and Auto-Regressive Transformers (BART) architecture.

7. The method of claim 6, wherein the chapterization model is evaluated during training on embedding based distance metrics.

8. A non-transitory computer-readable storage medium for storing instructions executable by a processor, the instructions comprising:
obtaining multi-party communication (MPC) data corresponding to an MPC, the MPC data comprising an audio component and an event timeline;
generating diarized MPC data based on the MPC data by segmenting the audio component and assigning an anonymized speaker label to each segment;
generating processed diarized MPC data by identifying the speaker corresponding to the anonymized speaker label based on the event timeline;
applying a summarization model to the processed diarized MPC data to generate an MPC summary; and
determining an MPC insight corresponding to the MPC based on the MPC summary and the MPC data.

9. The non-transitory computer-readable storage medium of claim 8, wherein the instructions further comprise generating the diarized MPC data by:
segmenting the audio component of the MPC data into overlapping segments;
determining at least two of an i_Vector, a d_Vector, and an x_Vector for each segment;
combining the at least two vectors for each segment;
clustering the combined vectors into an N-number of clusters, the N-number of segments corresponding to a number of speakers associated with the MPC; and
assigning the anonymized speaker label to each cluster.

10. The non-transitory computer-readable storage medium of claim 8, wherein the MPC insight is a set of MPC keywords and the instructions further comprise determining the MPC insight by:
extracting a plurality of video frames from a video component of the MPC data;
deduplicating the video frames to obtain unique frames;
performing Optical Character Recognition (OCR) on each unique frame to obtain a plurality of keywords; and
generating the set of MPC keywords by ranking the plurality of keywords.

11. The non-transitory computer-readable storage medium of claim 10, wherein the instructions further comprise ranking the plurality of keywords using a Term Frequency-Inverse Document Frequency (TF-IDF) technique.

12. The non-transitory computer-readable storage medium of claim 10, wherein the MPC insight is a set of MPC chapter names, the instructions further comprising determining the MPC insight by applying a chapterization model to the MPC keywords.

13. The non-transitory computer-readable storage medium of claim 12, wherein the chapterization model includes a Bidirectional and Auto-Regressive Transformers (BART) architecture.

14. A device comprising a processor configured to:
obtain multi-party communication (MPC) data corresponding to an MPC, the MPC data comprising an audio component and an event timeline;
generate diarized MPC data based on the MPC data by segmenting the audio component and assigning an anonymized speaker label to each segment;
generate processed diarized MPC data by identifying the speaker corresponding to the anonymized speaker label based on the event timeline;
apply a summarization model to the processed diarized MPC data to generate an MPC summary; and
determine an MPC insight corresponding to the MPC based on the MPC summary and the MPC data.

15. The device of claim 14, wherein the processor is further configured to generate the diarized MPC data by:
segmenting the audio component of the MPC data into overlapping segments;
determining at least two of an i_Vector, a d_Vector, and an x_Vector for each segment;
combining the at least two vectors for each segment;
clustering the combined vectors into an N-number of clusters, the N-number of segments corresponding to a number of speakers associated with the MPC; and
assigning the anonymized speaker label to each cluster.

16. The device of claim 14, wherein the MPC insight is a set of MPC keywords, the processor further configured to determine the MPC insight by:
extracting a plurality of video frames from a video component of the MPC data;
deduplicating the video frames to obtain unique frames;
performing Optical Character Recognition (OCR) on each unique frame to obtain a plurality of keywords; and
generating the set of MPC keywords by ranking the plurality of keywords.

17. The device of claim 16, wherein the processor is further configured to rank the plurality of keywords using a Term Frequency-Inverse Document Frequency (TF-IDF) technique.

18. The device of claim 16, wherein the MPC insight is a set of MPC chapter names, the processor further configured to determine the MPC insight by applying a chapterization model to the MPC keywords.

19. The device of claim 18, wherein the chapterization model includes a Bidirectional and Auto-Regressive Transformers (BART) architecture.

20. The device of claim 19, wherein the chapterization model is evaluated during training on embedding based distance metrics.
